(19) United States
(12) Patent Application Publication
(10) Pub. No.: US 2004/0053542 A1
(43) Pub. Date: Mar. 18, 2004

(54) Method for improving a link between a contact and strands of a cable

(76) Inventors: Daniel Gloaguen, Le Mans (FR); Thierry Quillet, La Milesse (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/620,961

(22) Filed: Jul. 16, 2003

(30) Foreign Application Priority Data
Jul. 17, 2002 (FR) FR 02 09089

(51) Int. Cl. H01R 4/10

(52) U.S. Cl. 439/877

(57) ABSTRACT

A method for improving the reliability of the electric connections between a termination of a cable and a wall of a contact with which it cooperates, in which it is provided that an intermediate metal layer will be pressed on the wall that has to cooperate with strands of the cable.

### BACKGROUND OF THE INVENTION

1. Field of the Invention

An object of the present invention is a method for improving an electric link between a contact and strands of a cable. An object of the invention is also a connector assembly obtained in this way. This method can be used more particularly in the field of aeronautics where the onboard equipment comprising connector assemblies of this kind is often subjected to strong variations of physical constraints (such as temperature, pressure, etc). Now, the different elements of these connector assemblies are not all made out of the same materials. Each material has a specific coefficient of expansion in response to these variations of temperature and pressure. A possible result of this is that two materials with different coefficients of expansion may be in contact with each other under certain conditions of temperature and pressure and no longer in contact under other conditions.

In the context of electric connections, the reliability of the electronic and electric instruments taken on board these aircraft is affected by these variations. To resolve this problem of security, solutions are provided to improve the reliability of the contacts even under these variations in external physical conditions.

2. Description of the Prior Art

These problems are seen especially in the case of copper contacts that have to be connected to aluminum strands of a cable, as copper and aluminum have very different coefficients of expansion.

In the case of the connection between a termination of a cable and a contact used to form a connection plug for this end of the cable, it is generally provided that a contact will be formed in which a barrel will be hollowed out at the first end in order to receive conductive strands of a cable therein. At a second end, this contact has a male or female shape so that it can be connected with a matching device. The first end of the contact is preferably crimped around strands of the cable. However, despite this crimping, there is a risk of obtaining faulty connections when the cable is subjected to temperature and pressure variations. To resolve this problem, there is a known way of placing an intermediate material between the contact and the strands of the cable. The coefficient of expansion of this intermediate material is in between that of the contact and that of the strands of the cable. Thus, connection is ensured in all circumstances.

The known methods used to implement this approach to consist, for example, in placing the contact that has to receive the end of the cable in an electrolytic bath so that the intermediate layer can be deposited on internal walls of the barrel of this contact. The problem however is that it is difficult to control the thickness of the electrolytic deposit made on the contact because the contact has shapes with numerous recesses and corners, especially in the case of the barrel, and because the thickness deposited throughout the rim of this wall is not homogeneous. Furthermore, another drawback of this technique of electrolytic deposition is that it entails a slow and therefore costly step.

Another prior art solution consists in making a ring by machining or punching in a material having an intermediate coefficient of expansion. This ring must then be forced-fitted into the contact in order to narrow the opening of the contact and thus reduce the aperture of the barrel that is supposed to receive the strands of the cable. Such an approach may be efficient and reliable but it also raises a problem since the making of the rings constitutes an additional step. Furthermore, the high-precision tools needed to insert such a ring in a contact are costly and there are major risks of damaging the barrel during assembly. Indeed, since the contacts generally have an aperture with a diameter of about 1 mm, the mounting of a ring into this aperture becomes a very painstaking process and therefore requires lengthy steps. Should the ring be badly mounted inside the barrel of the contact, this contact will be made permanently unusable. This technique therefore results in a high rate of rejects.

### SUMMARY OF THE INVENTION

It is an object of the invention to resolve the problems raised, i.e. to propose a reliable link between a contact and a cable while, at the same time, proposing a means for the assembly and easy manufacture of a connector assembly of this kind. To this end, the invention provides for the pressing of a metal layer made of ductile material against the wall of the contact. Should the strands of the cable be inserted inside the barrel of the contact, the metal layer is pressed against an inner wall of the barrel receiving the strands of the cable. To this end, in the method according to the invention, it is necessary to use a means for pressing a surface, for example a plane surface, inside the barrel which is, for example, a cylindrical barrel with an aperture facing the pressing means.

In one variant of the invention, it is planned to press this intermediate layer against an external wall of the first end of the contact, against which strands of the cable or a matching contact are placed and work in co-operation.

An object of the invention is a method for improving an electric link between a contact and a cable comprising strands, the strands of the cable being designed to co-operate with a wall of the contact, wherein an intermediate metal layer is pressed against this wall to make the strands co-operate with this metal layer.

### BRIEF DESCRIPTION OF THE DRAWINGS

The invention will be understood more clearly from the following description and from the accompanying figures. These figures are given purely by way of an indication and in no way restrict the scope of the invention. Of these figures:

FIG. 1 is a sectional view of a contact in which a metal layer has to be pressed according to a method of the invention;

FIG. 2 is a sectional view of the contact in which the conductive layer is pressed according to a method of the invention;

FIG. 3 is a sectional view of a contact during the second step of a method according to the invention;

FIG. 4 is a sectional view of a contact in which a metal layer has been pressed according to a method of the invention.

### MORE DETAILED DESCRIPTION

An object of the present invention is a method for improving a link between a contact and strands of a cable. In a first embodiment, the first end of the contact may be male and may have an external wall on which the strands of the cable may take support. According to a second embodiment, this first end of the contact may be female and, in this case, it has a barrel into which the strands of the cable are inserted. In this case, the strands of the cable come into contact with an inner wall of the barrel. The method according to the invention provides for pressing an intermediate metal layer made of ductile material on the wall of the contact which then has to be linked with the strands of the cable.

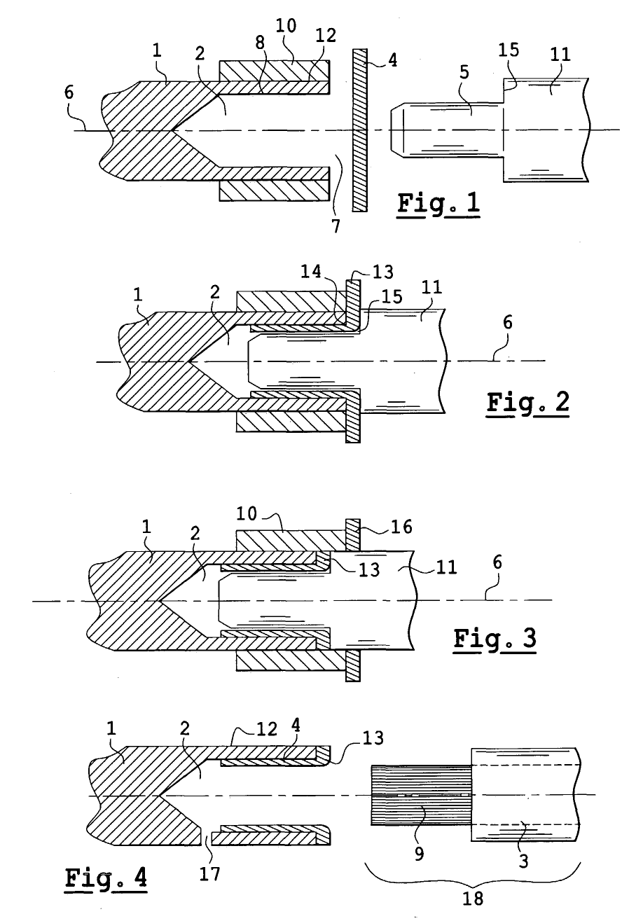

FIGS. 1 to 4 show a female contact 1 comprising a cavity 2, or barrel 2, for the reception therein of the cable 3 shown in FIG. 4.

The aim of the invention is to enable the pressing of a metal layer on the wall of the contact designed to receive the strands of the cable. The pressing operation consists in placing a sheet flat against a wall of the contact, and initially pushing center of the sheet into the cavity 2. To this end, in the method according to the invention, pressing means is used 5. The pressing means 5 are specific to the type of contact. FIGS. 1 to 4 show a female contact designed to co-operate with a first pressing means 5 dedicated to the precise type of cavity 2 of this contact 1.

The contact 1 has an elongated shape along an axis 6, and the cavity 2 forms a cylindrical barrel having an aperture 7 perpendicular to this axis 6. Parallel to this axis 6, the barrel 2 has walls 8 forming a ring of the cavity 2. The walls 8 are designed to co-operate with strands 9 of the cable 3.

For the operation of pressing a metal layer against this wall 8, there is a metal layer 4 with a relatively plane shape facing the aperture 7 and positioned perpendicularly to the axis 6. The metal layer 4 is obtained from a film made of a ductile material. That is, it can be stretched without breaking. This layer can be made of silver or tin. Preferably, a silver film with a thickness of about 0.1 mm is chosen if the contact 1 that receives this metal layer has the following dimensions: a diameter of about 1 mm for the aperture 7, a depth of about 2 to 5 mm for the walls relative to the axis 6 and a thickness of about 0.1 mm for these walls 8 themselves.

The pressing means 5 preferably comprises a die 10 and a punch 11. The punch 11 serves to push the metal layer 4 against the walls 8. The die 10 serves to retain the contact 1 in a given position relative to the punch 11 which is in motion. The die 10 rests, in this case, on external walls 12 of the contact 1. The punch 11 is preferably made of hardened steel in order to give it high resistance to wear and tear. Preferably, the film facing the aperture 7 is square-shaped, and a center of this square is centered relatively at the center of the aperture 7. The punch 11 is itself centered along the axis 6.

As shown in FIG. 2, the film formed by the metal layer 4 driven by the punch 11 is positioned along the walls of this punch 11. In entering the cavity 2, the punch 11 places the metal layer 4 flat against the walls 8. Under the pressure of the punch 11, the film is driven into the cavity 2, but it also undergoes an elastic deformation which, as the case may be, leads to a thinning of the layer of film placed flat against the wall 8 in a permanent position.

A surface formed by this film 4 is appreciably greater than the aperture 7. Hence, when the punch 11 drives a central part of this film 4 into the cavity 2, a portion 13 of this film remains outside the aperture 7. This excess portion of metal layer 4 is then placed flat against the edges 14 of the aperture 7 by means of a shoulder 15 in the punch 11. As indicated in FIG. 3, this excess portion 13 is broken by the shifting of the die 10 relative to the punch 11 and the contact 1 which are imbricated with each other. The die 10 is raised along the outer rim 12 parallel to the axis 6 toward the aperture 7. Thus, the part of the additional portion 13 that goes beyond the edge 14 is sectioned during the scissor motion made by the die 10 relative to the recess 15. Thus, a clean pressing is obtained in the metal layer 4 inside the cavity 2.

In the embodiment of the method shown, it can be seen that even if the material 4 is ductile, it may get partially cracked inside the cavity 2. This may lead to a break in the metal layer under the pressure of the punch 11. This break generally occurs in the central part of the layer 4, namely the part that is more deeply pushed into the cavity 2. Then, a distribution of this metal layer 4 is obtained on the inner walls 8, only on the walls parallel to the axis 6.

To withdraw the punch 11 from inside the cavity 2, when the metal layer 4 has been properly pressed, this punch 11 is withdrawn parallel to the axis 6. In order not to create any depression in the cavity 2 through the withdrawal of this punch 11 and to prevent the loosening of the freshly applied metal layer 4, it is possible if necessary to provide for an air discharge hole 17 as shown in FIG. 4. This hole 17 therefore connects the cavity 2 to the outer wall 12.

The contact 1 thus prepared is thus improved to ensure connection with the strands 9 of the cable 3. Indeed, assuming that the strands 9 are made of aluminum and that the body of the contact 1 is made of copper, the deposited metal layer 4 made of silver or tin provides relative continuity in the electric contact set up between the strands 9 and the contact 1.

From this contact 1, it is planned to partially bare a termination 18 of the cable 3, so as to present the strands 9 inside the cavity 2 once the cable is inserted in this cavity 2. For example, the walls 8 are crimped against the strands 9. In fact, it is the metal layer 4 that comes into contact with the strands 9 while at the same time remaining flat against the wall 8. It is thus possible to obtain a connector assembly between a contact and the cable.

What is claimed is:

1. A method for improving an electric link between a contact and a cable comprising strands, the strands of the cable being designed to cooperate with a wall of the contact, wherein an intermediate metal layer is pressed against this wall to make the strands cooperate with this metal layer.

2. A method according to claim 1, wherein coefficients of expansion of the strands of the cable and of the contact are different and wherein it is chosen to form the metal layer out of a ductile material.

3. A method according to one of the claims 1 to 2, wherein a layer of silver or tin is chosen for being pressed against the wall of the copper contact designed to cooperate with the aluminum strands of the cable.

4. A method according to one of the claims 1 to 3, wherein a pressing means is used, this means comprising a die and a punch, and wherein the die is placed around the contact, the punch being designed to drive the metal layer into a cavity against the wall.

5. A method according to claim 4 wherein the die is removed from the contact in sectioning the outer rim of the metal layer so as to form a collar at an aperture of the cavity.

6. A method according to one of the claims 4 to 5 wherein a punch made of hardened steel is chosen.

7. A method according to one of the claims 4 to 6 wherein the barrel has a hole to discharge the air contained in the cavity during the penetration by the punch.

8. A method according to one of the claims 1 to 7 wherein an external wall of the contact against which the strands are placed and with which they cooperate is covered by the metal layer.

9. A method according to one of the claims 1 to 8 wherein a metal layer 0.1 millimeter thick is used.

10. A connector assembly comprising a contact and a cable, strands of the cable being inserted into a cavity of the contact, a metal layer having been pressed beforehand against this wall by a method according to one of the claims 1 to 9.
